(19) United States
(12) Patent Application Publication
(10) Pub. No.: US 2007/0242374 A1
(43) Pub. Date: Oct. 18, 2007

(54) Kit for extending a holder of a side mirror mounted to a vehicle

(76) Inventors: James Helms, Fort Meyers, FL (US); Thomas G. Buckner, Gibsonia, PA (US)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(21) Appl. No.: 11/729,602

(22) Filed: Mar. 28, 2007

Related U.S. Application Data
(60) Provisional application No. 60/786,894, filed on Mar. 28, 2006.

(51) Int. Cl. G02B 7/182; G02B 5/08

(52) U.S. Cl. 359/881; 359/871

(57) ABSTRACT

A mirror extension kit providing a mirror extension bracket (10) for holding a mirror structure (31) to the side of a vehicle (41) at various possible lengths from the vehicle.

### CROSS REFERENCE TO RELATED APPLICATION

Reference is made to and priority claimed from U.S. provisional application Ser. No. 60/786,894 filed Mar. 28, 2006.

### BACKGROUND OF THE INVENTION

1. Technical Field

The present invention pertains to the field of automotive equipment and accessories, and in particular to equipment for mounting a mirror on the side of a vehicle.

2. Problem Solved by the Invention

The HMMWV (high mobility multipurpose wheeled vehicle), as well as other military and civilian vehicles, comes with mirrors mounted on the driver and passenger side abreast of the driver. The mirrors are held by a standard holder, and typically extend out a distance believed to be a suitable compromise between the need to keep the vehicle width within a predetermined envelope, and the need to be able to see close to the rear of the vehicle.

In many circumstances, it is advantageous for a vehicle, and especially a military vehicle such as the HMMWV, and especially in combat operations, to be able to see closer behind the vehicle than is allowed by the standard mirror holder.

What is therefore needed is a way to upfit such vehicles to allow for viewing closer behind the vehicles, i.e. to have one or more of the side mirrors held a greater distance out from the side of the vehicle.

### DISCLOSURE OF INVENTION

The invention provides a mirror extension kit comprising: a wholly or partially assembled mirror extension bracket, including a U-section having two arms, and including two leg extension sections each having a proximal end for telescopically connecting to a respective one of the leg extension sections, and a distal end configured for mounting to a point of attachment of a vehicle; and a locking mechanism for locking each of the leg extension sections into a respective one of the two arms at one or another of different possible lengths.

### BRIEF DESCRIPTION OF THE DRAWINGS

The above and other objects, features and advantages of the invention will become apparent from a consideration of the subsequent detailed description presented in connection with accompanying drawings, in which:

FIGS. 1A and 1B are perspective drawings of a mirror extension bracket provided by a kit according to the invention, shown attached to a HMMWV.

### DETAILED DESCRIPTION

The invention is here described being used to extend the length of side mirror holders of a HMMWV. However, it should be understood that nothing about the invention limits its use to a HMMWV.

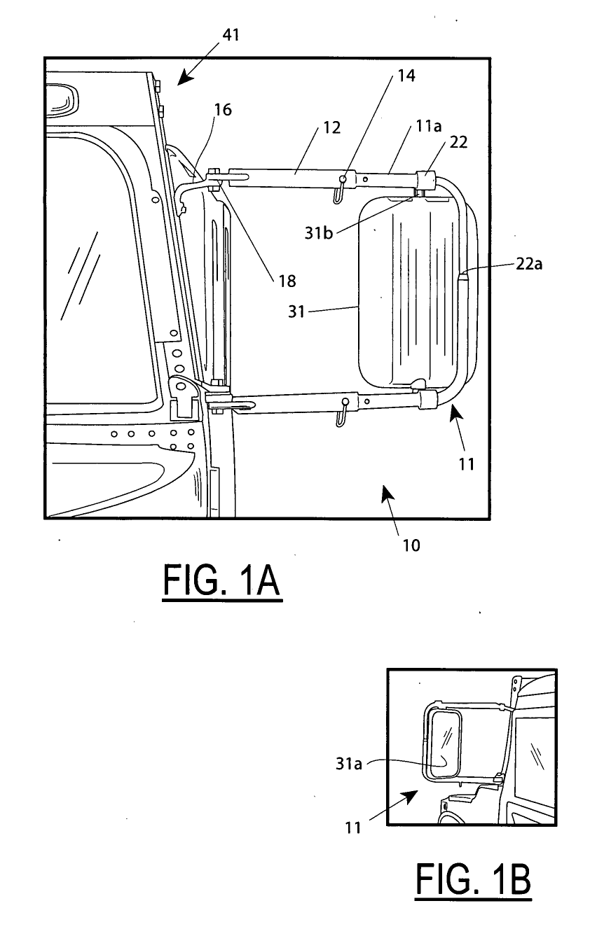

With reference to FIGS. 1A and 1B, the invention provides a mirror extension kit for holding a mirror structure 31 to the side of a vehicle 41 at various possible lengths from swiveling points of attachment 18 on bracket leg holders 16 affixed to the vehicle. The kit includes a mirror extension bracket 10. The bracket 10 has a U-section 11 with two arms 11a. The bracket 10 also has two leg extension sections 12 each having a proximal end for attaching to the U-section and a distal end configured for mounting to the vehicle at a respective one of the points of attachment 18. The bracket 10 includes one or another mechanism for locking the leg extensions into the U-section so as to hold the mirror structure away from the vehicle at a desired distance from the vehicle. Each end of the bracket 10 (i.e. each distal end of the leg extensions) is configured for mounting to a respective one of the bracket leg holders 16, and in particular so as to be able to swivel about a respective one of the points of attachment 18. The bracket leg holders are ordinarily not included in the kit, but are usually already attached to the vehicle.

The two arms 11a of the U-section are sized to fit inside or outside the proximal ends of the leg extension sections 12. This allows for a telescoping action, and so allows varying the overall lengths of the legs of the mirror extension bracket, including the arms 11a and the leg extension sections 12. In some embodiments, as shown in FIG. 1A, the locking mechanism includes locking pins 14 to lock the overall lengths of the legs at one or another of various lengths made possible by holes positioned along the length of each arm 11a and along the length of each leg extension section 12. One such length is the length provided as standard with the HMMWV.

In other embodiments, in case of the leg extensions 12 fitting inside the arms 11a, the locking mechanism includes for each end of the bracket 10, a ring structure threaded and rigidly attached to the distal end of the arm 11a, on the side away from the distal end, and having a collapsible section on the side nearer the end, and also includes an outer annular element threaded on its inside so as to screw onto the ring structure and in so doing collapse the collapsible section onto the leg extension, and thereby lock (by friction) the arm and leg extension at any length in a continuous range of lengths.

In other embodiments, the locking mechanism includes indicia provided in the arms 11a and leg extensions 12, in the form of protuberances on one and indentations on the other, so that by manipulation a protuberance can be arranged to fall into an indentation, and thereby lock the overall lengths of the legs at one or another of various lengths corresponding to the (one or more possibly different) separations between the indentations and the corresponding separations between the protuberances.

The mirror structure 31 can be provided already attached to the mirror extension bracket 10 as part of a kit according to the invention, or the mirror structure provided as standard with the vehicle can be used. In the latter case, to use the mirror extension bracket provide by the invention, the mirror structure already attached to the vehicle would be taken off the bracket that comes standard with the vehicle, and then attached to the mirror extension bracket provided with a kit according to the invention, using mirror attachments 22 to attach the mirror to the U-section provided with the invention. The mirror attachments 22 can be, as shown, ring structures having holes for receiving pins 31b extending from the mirror structure 31, so that the mirror structure can swivel within the bracket 10.

To allow for inserting the pins 31b into the U-section 11, the U-section can be provided so as to assemble from two halves by joining the two halves at a mating joint 22a after inserting the pins 31b into the mirror attachments 22. Of the two halves of such a U-section, one end of one half of the U-section can be provided so as to fit inside one end of the other half for a short distance, but sufficient in length to impart acceptable strength and rigidity to the assembled U-section.

The mirror extension brackets are typically made from anodized aluminum, although other materials of suitably high strength and high tolerance to harsh environmental conditions can also be used, such as chrome or even a high strength composite or plastic material.

It is to be understood that the above-described arrangements are only illustrative of the application of the principles of the present invention. Numerous modifications and alternative arrangements may be devised by those skilled in the art without departing from the scope of the present invention.

What is claimed is:

1. A mirror extension kit, comprising:
a wholly or partially assembled mirror extension bracket (10), including a U-section (11) having two arms (11a), and including two leg extension sections (12) each having a proximal end for telescopically connecting to a respective one of the leg extension sections (12), and a distal end configured for mounting to a point of attachment (18) of a vehicle (41); and
a locking mechanism (14) for locking each of the leg extension sections (12) into a respective one of the two arms (11a) at one or another of different possible lengths.

2. A mirror extension kit as in claim 1, wherein the locking mechanism (14) includes locking pins (14), and wherein the leg extension sections (12) and the arms (11a) all have a plurality of holes along their respective lengths, sized and positioned so that a hole in each leg extension section (12) can be lined up with a hole in one of the arms (11a) so as to be able to receive one of the locking pins (14) and thereby hold the arm (11a) and the leg extension section (12) at one or another of different possible predetermined lengths.

3. A mirror extension kit as in claim 1, wherein the locking mechanism (14) includes a mechanism for locking the leg extension sections (12) and the arms (11a) at any length in a continuous range of lengths.

4. A mirror extension kit as in claim 1, wherein the locking mechanism (14) includes indentations and/or protuberances in the leg extension sections and the arms (11a).

5. A mirror extension kit as in claim 1, wherein the U-section (11) is provided in two halves mated or mateable at a mating joint (22a).

6. A mirror extension kit as in claim 1, further comprising a mirror structure (31) including a mirror (31a) and having pins (31b) for inserting into mirror attaching means (22) affixed to or included as part of the U-section (11), for swivelably attaching the mirror structure (31) to the bracket (10).
